(19) United States
(12) Patent Application Publication
(10) Pub. No.: US 2015/0068864 A1
(43) Pub. Date: Mar. 12, 2015

(54) Duo spiral escalator with curved return

(71) Applicant: John Richard Strieter, Rock Island, IL (US)

(72) Inventor: John Richard Strieter, Rock Island, IL (US)

(21) Appl. No.: 13/998,868

(22) Filed: Sep. 12, 2013

(51) Int. Cl. B66B 21/06

(52) U.S. Cl. CPC B66B 21/06
USPC 198/328

(57) ABSTRACT

This invention describes the design of a carrier system for people or goods that provides a continuous path of travel of a duo spiral escalator ascending and descending around a cylindrical tower with all stairway treads remaining upright and in continuous operation. At the bottom level and at the top level of the spiral escalator the treads follow a curved path from one side of the tower to the other as they travel along two half circle tracks. At the end of the first half circle in the center of the tower, each tread is lifted from its tracks, rotated 180 degrees, and placed back down on the tracks at the beginning of the second half circle. This invention permits continuous transportation of the riders ascending and descending to a plurality of floors of varying ceiling heights.

### CROSS-REFERENCE TO A RELATED APPLICATION

Three inventors, have applied for a patent titled Duo Spiral Escalator with Direct Return. This invention differs from the Curved Return invention in that the treads take a direct path as they proceed from ascending to descending at the top floor of the spiral escalator. In the hidden transition space the treads gradually rise above the floor level and then drop back down to the floor level as they reverse direction. They exit the hidden space at the floor level traveling a short distance to allow passengers to step on before going down.

At the bottom floor of the spiral escalator the treads of the Direct Return invention take a direct path as they proceed from descending to ascending. In the hidden transition space the treads drop down below the level of the bottom floor and then rise back up to the floor level as they reverse direction. They exit the hidden space at the floor level traveling a short distance to allow passengers to step on before going up.

There is another difference between the two inventions. In the Curved Return invention, the treads follow a curved path as they travel along two half circle tracks at the top and bottom floors. At the end of the first half circle, each tread is lifted from its tracks, rotated 180 degrees, and placed back down on the tracks at the beginning of the second half circle.

### DESCRIPTION

### Background of the Invention

For many centuries spiral stairs have been a fascination for architects, designers, builders and owners. Even more fascination occurred when the spiral design encompassed single supports either on the exterior wall or on an interior column. As strength of materials improved, construction designs provided for supports at the base and the floor above. The greater the ceiling height the more complex and spectacular the designs became.

Compared with elevators, straight line escalators serving one floor at a time in both directions became an improvement in passenger movement where less than a dozen floors were involved.

Next came the transition from straight to curved and even spiral escalators. The preference for spiral escalators became popular since the design requires less horizontal space than straight escalators. A spiral escalator was constructed at London's Holloway Road underground station in 1906 only to be dismantled almost immediately. The Mitsubishi Electric Corporation has developed successful commercial designs and has manufactured curved and spiral escalators since the 1980s.

All of the designs are limited to serve only one pair of floors at a time. Separate escalators are required for ascending or descending installations and are usually constructed side by side, requiring a large horizontal space. Only half of the stair treads are in use at any time for all escalators, due to the continuous travel requiring the returning treads passing under the conveyor. This results in materials in use only half of the time.

Ever since 1883 when the first escalator (called “inclined elevator”) was invented, the escalator has been a favorite means for mass transportation of passengers in preference to vertical elevators. Through the years many inventions have been processed that attempted to improve the straight line escalators by: making more efficient use of the horizontal space required, serving multiple floors without requiring the passengers to leave and re-enter at each floor, using all steps all of the time, utilizing large vertical space, improving the aesthetics and architecture, and increasing passenger movement more economically and efficiently. This invention provides the design of a spiral escalator that achieves all of these aspirations.

### BRIEF SUMMARY OF THE INVENTION

This invention consists of the design of a continuous path of travel for a duo spiral escalator ascending and descending around a cylindrical tower. On the ascending side of the tower, a chain drive moves the treads up the escalator being powered by sprocket wheels. When the treads reach the top floor, they follow a short horizontal circular path allowing the riders to step off. Then the treads disappear from view and travel around a half circle to the center of the tower. At the center of the tower each tread is grabbed by a robot, lifted up, rotated 180 degrees, lowered, and placed on the next set of tracks. The treads then travel along a second half circle to the opposite edge of the tower. The chain drive on that side of the tower then pulls the treads back into view as they follow a horizontal circular path allowing the riders to step on just before descending.

On the descending side of the tower, a similar scenario describes how the treads are pulled down to the bottom floor where the riders step off, disappear and follow a half circle path to the center of the tower, are raised, rotated and lowered by a second robot, follow a second half circle path to the opposite side of the tower, and emerge ready for riders to step on and go up.

The forward motion of the escalator treads changes from ascending to descending at the top floor, and from descending to ascending at the bottom floor. This permits continuous transportation of the riders to a plurality of floors of varying ceiling heights. At each floor the treads travel horizontally for a short distance allowing time to step on and off. Riders may enter or exit at the bottom floor, at the top floor, or at any intermediate floor. At all intermediate floors they may also continue standing on the treads to the next floor.

As the treads move between floors, all of them may have riders aboard.

### BRIEF DESCRIPTION OF THE DRAWINGS

FIG. 1 is the top view of the duo spiral escalator showing the two half circle tracks at the top floor.

FIG. 2 is the top view of the two half circle tracks at the top floor, separate from the rest of the escalator.

FIG. 3 is the isometric view of the two half circle tracks at the bottom floor.

FIG. 4 is an isometric view of the entire escalator illustrating the delivery locations of riders to individual floors.

FIG. 5 is the same view as FIG. 4 without the floors depicted to better show the escalator treads and central tower.

FIG. 6 is an isometric view of the escalator with four floors.

FIG. 7 shows the escalator without the central tower.

FIG. 8 is an isometric view of the two half circle tracks at the top floor showing how a robot lifts a tread and rotates it 180 degrees.

### DETAILED DESCRIPTIONS OF THE DRAWINGS

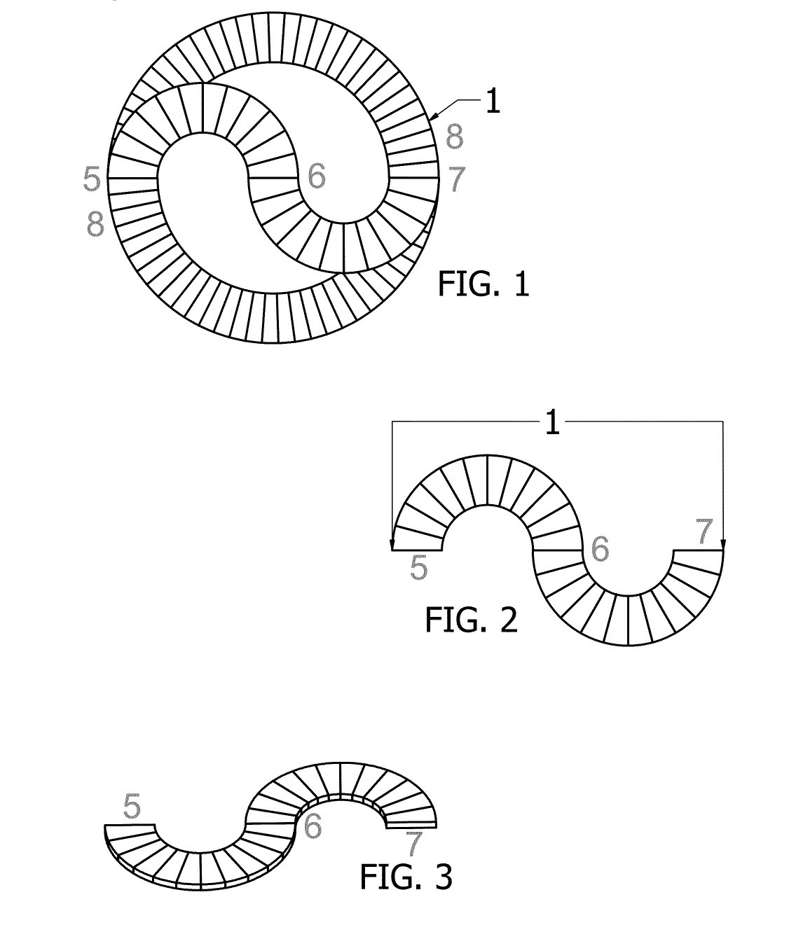

FIG. 1 depicts the top view of the escalator showing the two half circle tracks at the top floor connecting the duo spiral escalator. On the left side of the drawing, the tracks at the beginning of the first half circle 5 connect to a set of level treads 8 where riders exit the escalator at the top floor. On the right side of the drawing, the tracks at the end of the second half circle 7 connect to another set of level treads 8 where riders enter the escalator and prepare to descend. 6 marks the intersection of the two half circle tracks. The external diameter of the descending and ascending stair treads 1 is equal to the diameter of the space occupied by the two half circle tracks.

FIG. 2 is the top view of the two half circle tracks at the top floor. All of the treads are at the level of this floor. The diameter of the cylindrical escalator tower 1 defines its footprint.

FIG. 3 is the isometric view of the two half circle tracks at the bottom floor. Note the curving in the opposite direction when compared to the top floor tracks. These track locations could be interchanged, FIG. 3 corresponding to the top floor and FIG. 2 corresponding to the bottom floor, depending on whether a left-handed or right-handed twist is desired for the spiral.

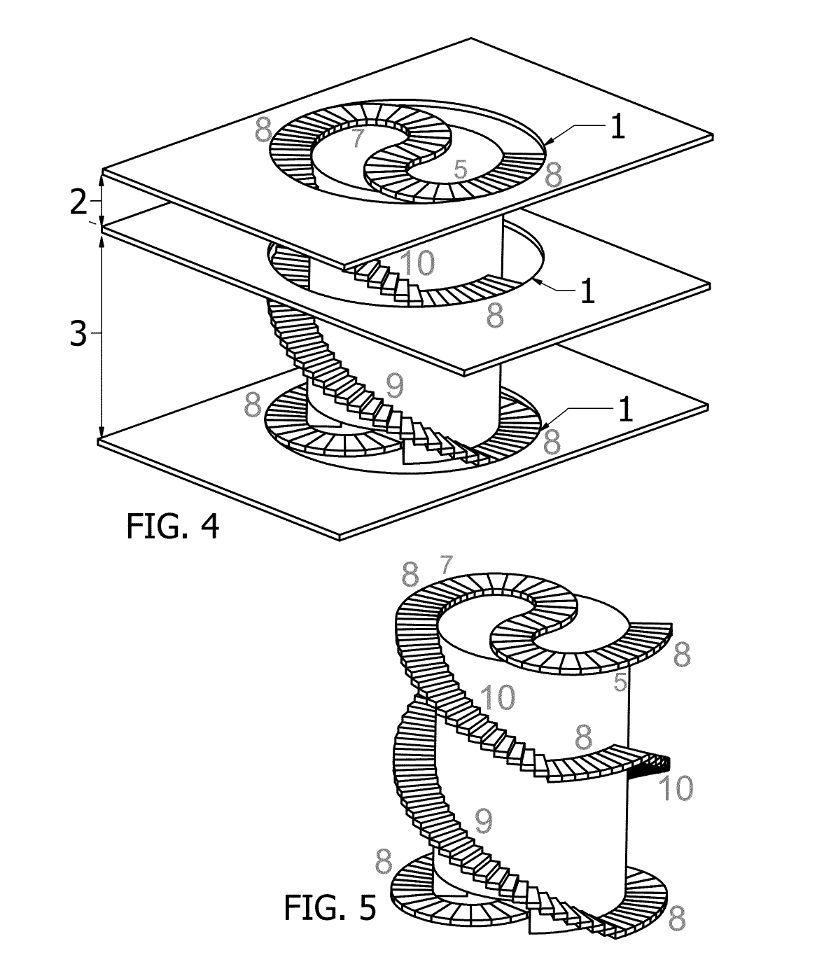

FIG. 4 is an isometric view of the escalator including floors. It demonstrates that riders can be received and delivered at a plurality of floors, three in this figure. A plurality of ceiling heights can also be achieved, as shown by 2 and 3. Note that all floors have a common center and diameter 1. In FIGS. 4-7, when the escalator treads are in motion, the treads that are going up are labeled 9 and the treads that are going down are labeled 10. The label 8 is used to designate where riders enter and/or exit the escalator while the treads are moving along a horizontal circular path.

FIG. 5 is the same as FIG. 4 but with the floors removed for clarity. It shows the ascending and descending stairs becoming level treads 8 at each floor for riders to enter and exit the escalator on opposite sides.

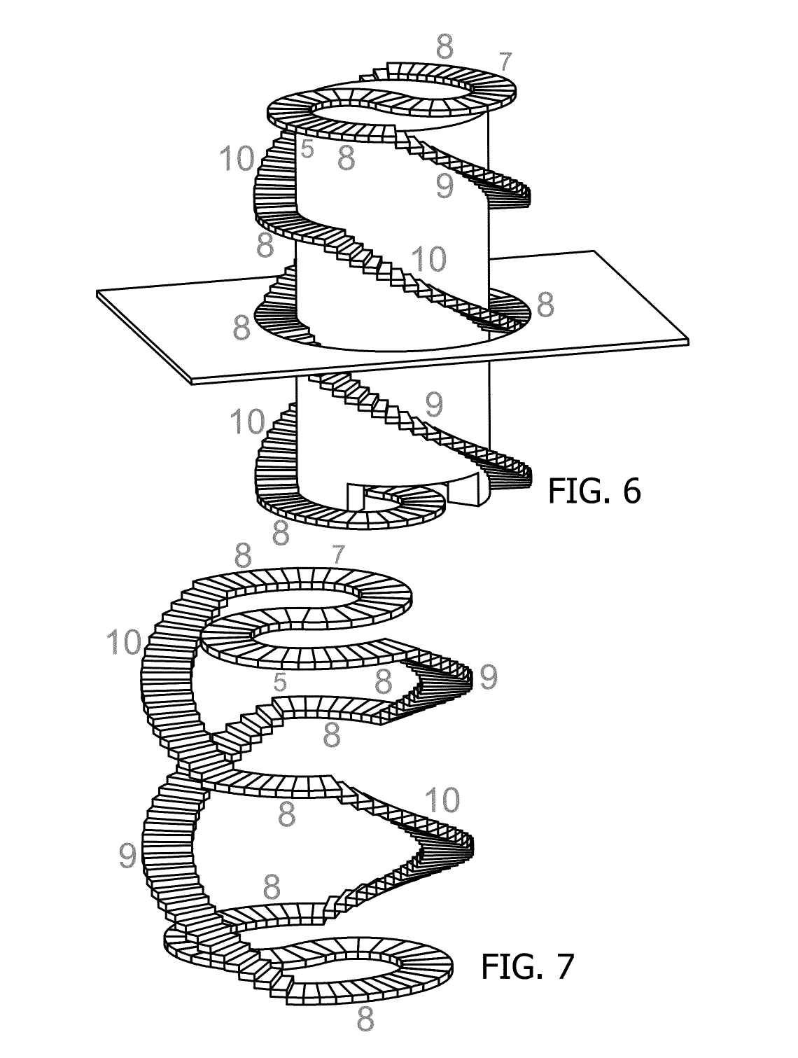

FIG. 6 shows another isometric view. There are a total of four floors here with the plane drawn to illustrate the second floor. Note the tread feed through at the bottom floor.

FIG. 7 is an isometric view showing all of the treads with the center tower removed, allowing for maximum aesthetics.

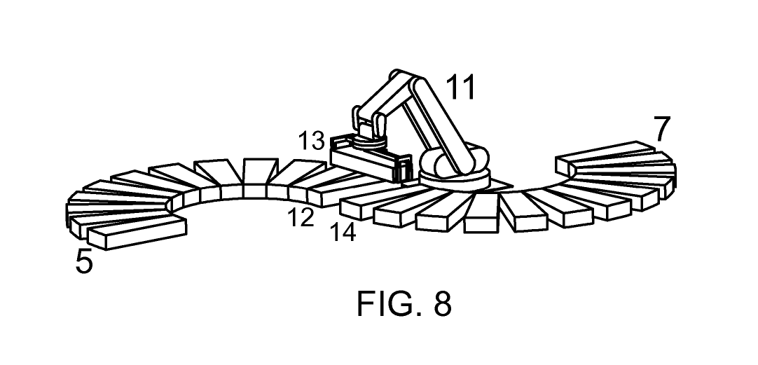

FIG. 8 is an isometric view of the two half circle tracks at the top floor. Unlike the drawings in FIGS. 1-7 which are schematic in showing close-packed treads at the top and bottom floors, FIG. 8 accurately shows the space between the treads. It illustrates how a robot 11 grabs each tread 12 at the end of the first half circle track, lifts it up, rotates it 180 degrees, lowers it, and places it at the beginning of the second half circle track 14. The empty robot then returns in time to pick up the next tread 12. The drawing is a snapshot that shows the robot after it has rotated the raised tread 90 degrees 13 in the middle of its 180 degree rotation. A second identical robot is required at the bottom floor, situated at 6 in FIG. 3, for the purpose of reversing the tread orientation by 180 degrees.

1. A duo spiral escalator with curved return, provides for simultaneous movement of all of the escalator treads on multiple floors by means of tracks and chains around the outside of a cylindrical tower, with the ascending and descending duo spiral escalator treads being connected along curved tracks on the top and bottom floors, allowing for continuous operation of the entire system.

2. The duo spiral escalator of claim 1, provides for service to a plurality of floors such that the riders may remain standing on the treads at all intermediate floors to continue on without stepping off to walk to a separate escalator.

3. The duo spiral escalator of claim 1, provides for a plurality of ceiling heights between floors.

4. The duo spiral escalator of claim 1, provides for all escalator treads to move between floors with riders aboard.

5. The duo spiral escalator of claim 1, provides for entering and exiting at each floor on opposite sides of the escalator tower.

6. The duo spiral escalator of claim 1, provides for both ascending and descending stair treads to be in one central structure with a common center and a common diameter.

7. The duo spiral escalator of claim 1, provides for either an open structure for maximum observation and aesthetics or a solid interior enclosed tower for economy.

8. The duo spiral escalator of claim 1, provides for ease of maintenance due to all treads being upright.

9. The duo spiral escalator of claim 1, minimizes mechanical designs and operations due to common and consistent diameters.

10. The duo spiral escalator of claim 1, provides for a small footprint.
